(19) United States
(12) Patent Application Publication
(10) Pub. No.: US 2026/0162190 A1
(43) Pub. Date: Jun. 11, 2026

(54) SYSTEM AND METHOD FOR ALLOCATING AND COMPUTING MULTI-POINT USE TAX OBLIGATIONS

(71) Applicant: Ryan, LLC, Plano, TX (US)

(72) Inventor: Sam Guevara, Ladera Ranch, CA (US)

(21) Appl. No.: 19/415,673

(22) Filed: Dec. 10, 2025

Related U.S. Application Data
(60) Provisional application No. 63/730,237, filed on Dec. 10, 2024.

(51) Int. Cl. G06Q 40/10

(52) U.S. Cl. CPC G06Q 40/10

(57) ABSTRACT

The present MPU tax allocation and computation system and methods dynamically allocate taxes for multi-point interactions with Computing Resource Platforms (CRPs). The framework processes hierarchical datasets—including facility access credential data, digital access data, and personal identification data—validated through temporal, geospatial, and policy-based checks. An audit trail ensures transparency and compliance, while customizable tax calculations consider licensing models, jurisdictional rates, and interaction volumes.

### CROSS REFERENCE TO RELATED APPLICATIONS

The present application claims priority to U.S. Provisional Application No. 63/730,237 filed on Dec. 10, 2024, which is incorporated herein.

### FIELD OF THE DISCLOSURE

The present invention relates generally to the field of tax computation for preparation of tax returns or tax payments, and, more particularly, it relates to a system and method for analyzing user interactions with computing resource platforms, such as, but not limited to, enterprise software systems, and other infrastructure or resources to determine the taxable amount arising from such interactions.

### BACKGROUND

Businesses are increasingly confronted with complex multiple points of use (MPU) taxes as they grow and scale across multiple states and countries. MPU tax computation refers to the process of determining and calculating tax obligations on enterprise systems (enterprise systems and other similar resources and platforms described as “Computing Resource Platforms” or “CRPs” herein), meaning a system, software, or device that enables digital interaction or resource consumption capable of generating transaction data relevant to tax allocation, used in multiple jurisdictions (e.g., different states or countries). A Computing Resource Platform (“CRP”) encompasses any environment through which an individual or system accesses, executes, or consumes digital functionality or data, including but not limited to interactive software-as-a-service platforms, platform-as-a-service (PaaS) platforms, infrastructure-as-a-service (IaaS) platforms, installed or on-premises software, hardware devices such as laptops or terminals that host or enable software interaction, and infrastructure or platform services that meter computer, storage, or network resources. All such environments are treated interchangeably for purposes of allocating and computing jurisdictional tax obligations. Such computations are relevant for businesses with multiple locations or a distributed workforce. In an example, a software company in Illinois may have a cloud-based Software-as-a-Service (SaaS) marketing CRP subscription for 10 marketing employees. Five of those employees are based in Illinois, while the remaining five are in Texas. Texas SaaS use tax rates may be lower than Illinois SaaS use tax rates. Failing to apply proper MPU tax computation logic and using only the Illinois tax rate can lead to overpayment on SaaS usage taxes. Or, applying only the Texas tax rate can lead to an underpayment and ultimately exposes the business to an audit risk. Therefore, to address such risks, many companies utilize various methods and tools to determine their CRP usage and sales tax obligations for each state where the CRP is used.

Conventional MPU tax computation methods, such as manual allocation or estimation, have been used by corporate accounting departments for decades, but despite their long-standing use, these antiquated, manual methods present significant challenges, primarily in terms of accuracy and time. Specifically, the process for determining a user's location, determining whether the user's interaction with a CRP qualifies as a taxable event, and determining the appropriate tax amount can take a significant amount of time and oversight, especially for large companies with a large number of users across multiple states. Further, despite all this effort, there is a high risk the final tax determination will not be accurate. As a result, many companies pay higher or lower than necessary CRP use taxes. These challenges are especially acute as businesses increasingly employ remote, hybrid or hoteling workforces that do not access their CRPs from a single constant office location.

Several tax payment systems and tools have started to address some of the challenges faced by manual, traditional methods, yet many of these software and tools still rely on outdated methodologies and technologies. For instance, most (if not all) tax systems currently on the market do not have the capability to allocate taxes dynamically across multiple taxing authorities or distinguish between taxable interactions and non-taxable interactions with CRPs. Further, such tax allocation systems may comprise only generic tax calculations that do not reflect the complexity and nuances of both U.S. tax law and international tax laws. While these systems may be more efficient than manual methods, there is still a high potential for errors. Accordingly, there exists a long-felt but unmet need for an MPU tax computation system and method which tracks when an individual interacts with a CRP, which taxing jurisdiction properly applies to the individual's interactions with the CRP, distinguishes between taxing jurisdictions and non-taxing jurisdictions, determines whether the interaction qualifies as a taxable event, and calculates the tax amount.

Additionally, many enterprises misallocate CRP use tax when headcount and actual use diverge, for example where hybrid teams spend significant time outside an assigned office jurisdiction. Conventional MPU methods rely on HR tables or invoice ship-to fields, which fail to capture multi-location work patterns and produce both over-and under-remittance. Accordingly, there exists a long-felt but unmet need for an MPU tax computation system and method that properly allocates use tax without relying exclusively on HR tables or invoice ship-to fields.

### SUMMARY

To address the above and other deficiencies with existing MPU tax allocation and computation methods and systems, the present invention contemplates a method and system for improved MPU tax allocation and computation by analyzing user interactions with various CRPs and other resources to determine meaningful taxable events which are then further analyzed and computed to determine an appropriate tax amount.

Various embodiments of an MPU tax computation system and method are disclosed.

According to a preferred embodiment, a system and method for allocating and computing MPU tax associated with an individual interacting with a CRP comprises: receiving transaction data, wherein the transaction data comprises at least one of certain transaction data type categories; dividing the transaction data into one or more transactional base units using one of three unit allocation methods; standardizing each of the one or more transactional base units into a common format; prioritizing categories of transaction data within the one or more transactional base units and identifying a location within the one or more transactional base units based on the certain prioritization hierarchy; consolidating all of the transactional base units for a given day and associating the consolidated transactional base units for a given day to an allocated record; allocating full allocation units or partial allocation units for each identified location in the allocated record; validating the allocated record; identifying a taxing authority corresponding to each location and an applicable usage tax rate for each location; and calculating a total tax applicable to each location using the full allocation units and partial allocation units and the applicable usage tax rate for each location to allocate a multi-point usage tax based on the amount of time attributed to a plurality of individuals associated with the locations.

These as well as other embodiments are hereby disclosed or are obvious to one of ordinary skill in the art from and encompassed by the following figures/drawings and detailed description.

### BRIEF DESCRIPTION OF FIGURES

Certain embodiments are shown in the drawings. However, it is understood that the present invention is not limited to the methods and systems shown in the attached drawings.

FIG. 1a is a block diagram illustrating a preferred system for determining tax obligations based on the proportion of a CRP's use in multiple locations according to an embodiment of the invention.

FIG. 1b is a block diagram illustrating a preferred system in which a data communication module is shown being external to the system for determining tax obligations based on the proportion of a CRP's use in multiple locations according to an embodiment of the invention

FIG. 2 is an enhanced block diagram illustrating transaction data and a data communication module and transaction processing module of the preferred system according to an embodiment of the invention.

FIG. 3 is an enhanced block diagram illustrating a transaction processing module of the preferred system according to an embodiment of the invention.

FIG. 4a is an enhanced block diagram illustrating a time interval unit allocation method of a unit module of a transaction processing module of the preferred system according to an embodiment of the invention.

FIG. 4b is an enhanced block diagram illustrating a transaction event unit allocation method of a unit module of a transaction processing module of the preferred system according to an embodiment of the invention.

FIG. 4c is an enhanced block diagram illustrating a day unit allocation method of a unit module of a transaction processing module of the preferred system according to an embodiment of the invention.

FIG. 5a is an enhanced block diagram illustrating a prioritization method of a prioritization module of a transaction processing module of the preferred system according to an embodiment of the invention.

FIG. 5b is an enhanced block diagram illustrating another prioritization method of a prioritization module of a transaction processing module of the preferred system according to an embodiment of the invention.

FIG. 6a is an enhanced block diagram illustrating a first allocated record of the preferred system according to an embodiment of the invention.

FIG. 6b is an enhanced block diagram illustrating a second allocated record of the preferred system according to an embodiment of the invention.

FIG. 6c is an enhanced block diagram illustrating a third allocated record of the preferred system according to an embodiment of the invention.

FIG. 6d is an enhanced block diagram illustrating a fourth allocated record of the preferred system according to an embodiment of the invention.

FIG. 6e is an enhanced block diagram illustrating a fifth allocated record of the preferred system according to an embodiment of the invention.

FIG. 6f is an enhanced block diagram illustrating a sixth allocated record of the preferred system according to an embodiment of the invention.

FIG. 7 is an enhanced block diagram illustrating steps followed by a prioritization module and location unit module of a transaction processing module of the preferred system according to an embodiment of the invention.

FIG. 8 is an exemplary screen illustrating an allocation screen of a user application of the preferred system according to an embodiment of the invention.

FIG. 9 is an exemplary screen illustrating an MPU overview screen of a user application of the preferred system according to an embodiment of the invention.

FIG. 10 is an exemplary screen illustrating an MPU overview screen of a user application of the preferred system according to an embodiment of the invention.

FIG. 11 is an exemplary screen illustrating an alternative allocation and computation scenario of a user application according to an embodiment of the invention.

### DETAILED DESCRIPTION

For the purposes of promoting and understanding the principles disclosed herein, reference is now made to the preferred embodiments illustrated in the drawings, and specific language is used to describe the same. The specific embodiments illustrated in the drawings and described in the following specification are simply exemplary embodiments or aspects of the invention. Therefore, it is nevertheless understood that alternative embodiments that utilize one or more of the principles disclosed and illustrated herein are contemplated as within the scope of the present invention.

This disclosure as a whole may be best understood by reference to the following detailed description when read in conjunction with the accompanying drawings, drawing descriptions, abstract, background, field of disclosure, and associated headings. Identical reference numbers when found on different figures identify the same elements or a functionality equivalent element. The elements listed in the abstract are not referenced but nevertheless refer by association to the elements of the detailed description and associated disclosure.

As used herein, the terms “about,” “approximate,” and variations thereof, are used to indicate that a value includes the inherent variation or error for the device, system, or measuring method being employed as recognized by those skilled in the art.

The MPU tax allocation and computation system and methods disclosed herein provide significant benefits in addressing complex tax nexus determinations, particularly in jurisdictions with nuanced or evolving rules regarding cloud-based services. By dynamically allocating taxes based on real-time data validation, the system minimizes the risk of tax liability misallocation, ensuring compliance with varying jurisdictional requirements and reducing potential overpayment or underpayment risks. Unlike existing systems that rely on static tax allocation, the MPU tax allocation system dynamically adjusts to user interactions across locations and jurisdictions, providing real-time validation and error handling. The disclosed system ingests multiple independent data categories, validates temporal and geospatial plausibility, then allocates fractional “time-in-jurisdiction” units that drive return-ready tax outputs. This approach improves apportionment accuracy and auditability compared with static, location-of-record methods. Preferred embodiments will now be discussed with respect to the drawings. From the preferred embodiments, persons with ordinary skill in the art will recognize additional features and broader aspects of the invention.

### Overview of the System

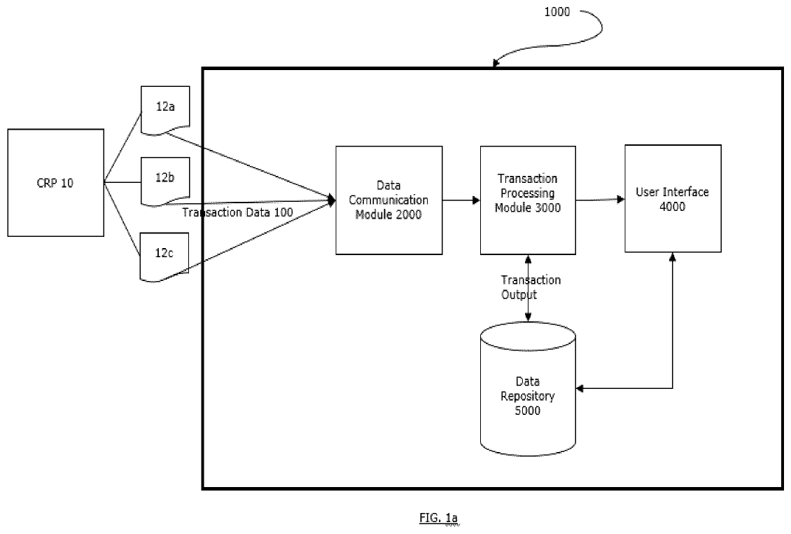

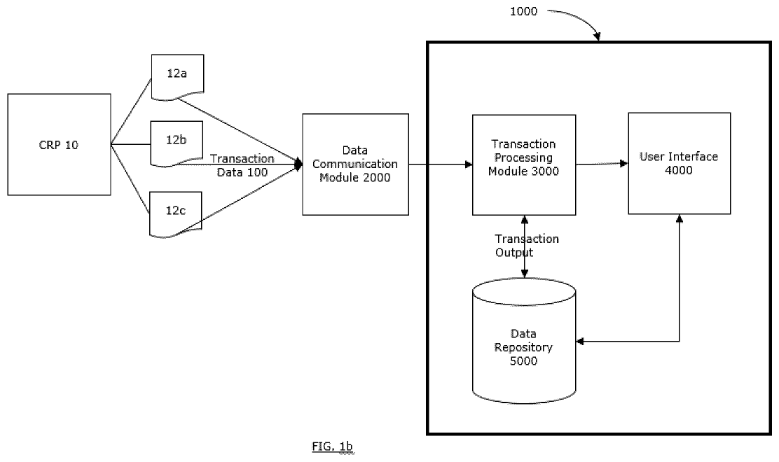

FIGS. 1a-1b depict an overview of a system 1000 for determining tax obligations based on the proportion of a CRP's use in multiple locations according to an embodiment of the invention. The system 1000 comprises a network, one or more external computing resource platforms (also described as “CRP” or “CRPs” herein) 10, one or more modules including a data communication module 2000 and a transaction processing module 3000, a user interface 4000, and a data repository 5000. In embodiments, the data communication module 2000 may be structured as a single module performing multiple functions, or as distinct modules, each performing a certain functionality. Similarly, in embodiments, the transaction processing module 3000 may be structured as single module performing multiple functions, or as distinct modules, each performing a certain functionality. Further, in embodiments, the data communication module 2000 and transaction processing module 3000 may be functions or portions of a single software application. In alternative embodiments, the data communication module 2000 and the transaction processing module 3000 may be distributed and/or separate components, such as separate applications, software, and/or platforms. The foregoing modules are described separately herein for clarity and to highlight each module's distinct function. The foregoing modules, individually or in combination, are programmed to specifically run the processes and algorithms disclosed further herein to collectively calculate and provide to the user a properly calculated taxable amount in a distributed MPU system. In an alternative embodiment, the system 1000 can include different or additional modules.

The network may be one or more networks including, Ethernet, LAN, WAN, WiFi, cellular network, and the like.

In the preferred system 1000, data transactions between the data communication module 2000 and the transaction processing module 3000 are exchanged using conventional digital transfer methods, such as secure file transfer protocol (FTP), secure FTP (SFTP), message bus subscription, or other comparable batch-transfer processes. For example, the data communication module 2000 may reside within an enterprise processing environment, while the transaction processing module 3000 and the data repository 5000 may operate within a tax-services processing environment (e.g., the system 1000) (as shown in FIG. 1b). In this preferred configuration, transaction files are periodically transferred from the enterprise environment to the tax-services environment for validation and computation. In other contemplated embodiments, the same data exchange may be performed through application-programming-interface (API) connections that enable near-real-time communication between modules. In such implementations, the data communication module 2000 may be deployed as an integration tier behind an API gateway, with raw payloads staged briefly for validation before being processed by the transaction processing module 3000. Regardless of the transfer mechanism, data is transmitted using secure protocols and stored in encrypted repositories with logical segmentation by tenant, thereby maintaining data integrity and consistent computational results.

The external CRPs 10 communicate transaction data 100 to the system 1000 through the data communication module 2000. In the current embodiment, this transfer occurs via periodic file exchange (e.g., FTP or secure batch upload). In other embodiments, the same data may be transmitted through an API interface or other network services that provide near-real-time exchange. Regardless of the method, the system applies identical processing, validation, and allocation logic to the received data.

The data communication module 2000 is configured to receive transaction data 100 comprising information pertaining to interactions of CRP users across multiple geographic locations. Specifically, the transaction data 100 comprises (a) identification data of a CRP user or a device interacting with a CRP 10, (b) digital access data that is produced when a CRP user interacts with the CRP 10 at one or more geographical locations, and (c) facility access credential data that is produced when a CRP user uses a facility access credential (e.g., building badge) to access one or more locations (e.g., corporate headquarters, processing warehouse, satellite office, and the like) having the ability to provide interaction with the CRP 10. The data communication module 2000 communicates, via the system 1000, the transaction data 100 to a transaction processing module 3000. In some embodiments, such as where file transfer latency is acceptable or legacy systems are used, the CRPs 10 may communicate transaction data 100 directly to the transaction processing module 3000 through secure file exchange rather than through the data communication module 2000. In other embodiments employing API integrations, the data communication module 2000 may act as a pass-through that authenticates and standardizes real-time transactions.

With continued reference to FIGS. 1a-1b, the transaction processing module 3000 processes transaction data 100, received from the data communication module 2000. Once the transaction data 100 is processed by the transaction processing module 3000, the transaction processing module 3000 communicates any transaction output to a user interface 4000 for the user to view and interact with information in real time.

With continued reference to FIGS. 1a-1b, the transaction processing module 3000 is in communication with a data repository 5000 for storing and retrieving transaction data 100 and transaction output created by the transaction processing module 3000. The data repository 5000 may be a suitable storage location, such as a data lake, a data warehouse, a data lake house, or an equivalent data storage location. Transaction output (described in detail below) can include transaction base units, location data, allocated records, and tax computations. The system 1000 and other external systems may access data stored in the data repository 5000 for further upstream and downstream processing. The data repository 5000 in turn is in communication with a user interface 4000. The user interface 4000 retrieves transaction data and transaction output from the data repository 5000 in response to a user prompt or query.

### Transaction Data and the Data Communication Module

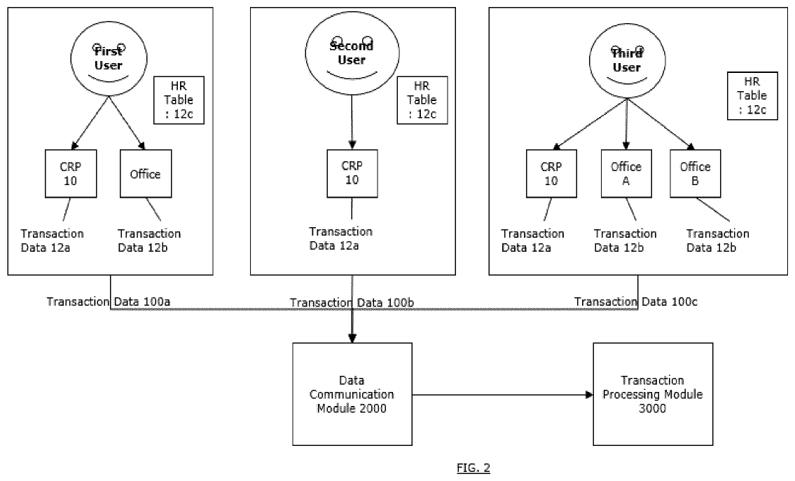

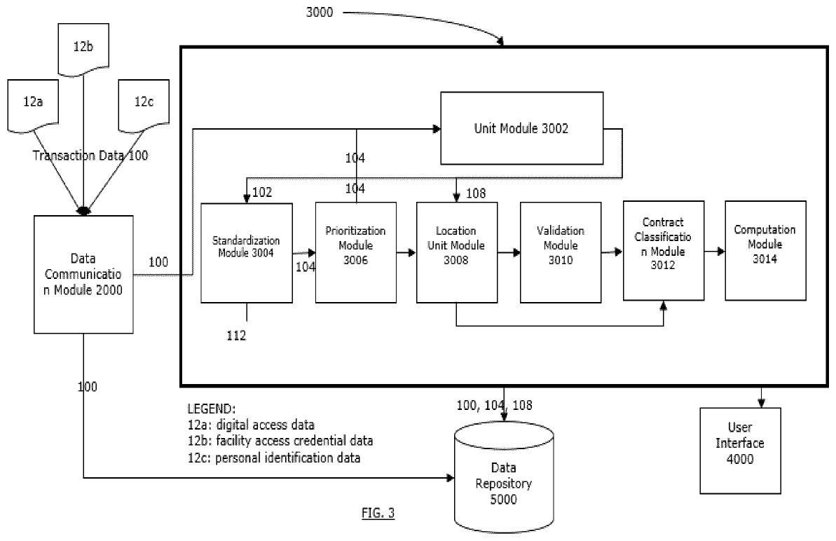

Transaction data 100 refers to any user interaction information and other information relevant to determine tax obligations and allocation. With continued reference to FIGS. 1a-1b and referring now to FIGS. 2-3, transaction data 100 can originate from multiple sources, with each source contributing unique and relevant information pertaining to a user's interactions with a CRP 10. A key source is system-generated digital access data (also described as “digital access data” herein) 12a, which is produced when a user interacts with a CRP 10 at one or more geographical locations. Another key source is facility access credential data 12b, which is produced when a user uses a facility access credential to access one or more locations (e.g., corporate headquarters, processing warehouse, satellite office, and the like) having the ability to provide interaction with a CRP 10. Another source are HR tables, which store personal user and device identification data (also described as “identification data” herein) 12c of users or devices interacting with CRPs.

A user's interaction with a CRP 10 at one or more geographic locations generates digital access data 12a which comprises a metadata trail or log information detailing a user's interactions with the CRP 10. Digital access data 12a can identify or closely approximate a user's location. The digital access data 12a that is produced when a user interacts with the CRP 10 at geographic location includes, but is not limited to, IP address, Unique device identifier (UDI), International Mobile Equipment Identifier (IMEI), Media Access Control (MAC) address, Device ID, serial number, and geolocation information. Additionally, digital access data 12a will preferably include time and location data, which can include: CRP or system access times, login times, data transmission times, data transmission volumes, or other data showing CRP or system interaction or usage.

Facility access credential data 12b includes, but is not limited to, data produced by the use of: security badges, fobs, near field communications (NFC) tags, radio frequency identification (RFID) tags, Quick Response Code Login (QRL), user-specific computational systems (phones), fingerprints, palm prints, facial recognition, retinal/iris scanning, or other equivalents. Generation of facility access credential data 12b occurs when a user uses one of the foregoing security credential elements to gain access to a location (e.g., corporate headquarters, processing warehouse, satellite office, and the like) having the ability to provide interaction with the CRP 10.

Identification data 12c of a user or device interacting with a CRP 10 comprises data commonly maintained by a human resources (HR) division, such as, but not limited to: user ID, username, certain employment dates, employee type, assigned office location, home work location, home state, home county, home city and home zip code. The home work location (including the accompanying home state, home county, home city and home zip code) is the location where a CRP user works when working remotely away from the office.

Collectively, digital access data 12a, facility access credential data 12b, and identification data 12c are referred to as “transaction data” 100 or “categories (12a, 12b, 12c) of transaction data” herein. In addition, collectively, digital access data 12a and facility access credential data 12b are referred to as “generated categories (12a, 12b) of transaction data” herein. Generated categories (12a, 12b) of transaction data come into existence only when a specific event or trigger occurs, whereas personal identification data 12c is already existing data and does not depend on any trigger or event to be created. For instance, when an employee uses a security badge to access their work location and accesses an enterprise software to perform tasks, then both facility access credential data 12b or digital access data 12a may be generated. Whereas the employee's information in an HR table maintained by a human resource division is already existing data and is not generated by a specific event or trigger.

As a non-limiting, high-level example, shown in FIG. 2, a first user, such as a salesperson, uses a security badge to access their work location and accesses a customer relationship management platform to track and manage their clients and potential leads. These interactions produce transaction data 100 comprising digital access data 12a (when the user interacted with a customer relationship management CRP) and facility access credential data 12b (when the user accessed their work location via a building security badge). A second user, such as a marketing manager, working from home accesses the same customer relationship management platform to manage and track marketing leads. This interaction produces transaction data 100 comprising digital access data 12a (when the user interacted with a customer relationship management CRP). A third user, such as an additional salesperson, uses a first security badge to access their first work location, e.g., company headquarters, and a second security badge to access their second work location, e.g., a satellite office. In addition, at both work locations, the third user accesses the same customer relationship management platform to manage and track their sales leads. This interaction produces transaction data 100 comprising digital access data 12a (when the user interacted with a customer relationship management CRP) and facility access credential data 12b (when the user accessed their first work location and second work location via a building security badge). In addition, each of the three users'identification information is stored within their companies'respective HR tables and this identification information is personal identification data 12c. As shown in FIG. 2, the resulting transaction data 100a, 100b, 100c is communicated to a data communication module 2000. In an embodiment, the data communication module 2000 may reside as a separate module or component in the client enterprise processing environment and communicate transaction data 100 to the system 1000 (as shown in FIG. 1b). As a non-limiting example, in such embodiment, the data communication module 2000 may be a component of a CRP and is configured to receive transaction data 100 from the CRP or an external client team may manually upload a transaction data file comprising transaction data 100 to the data communication module 2000. In alternative embodiments, transaction data 100 may be communicated directly to a transaction processing module 3000 via any suitable communication method such as an API.

In an embodiment, communication of transaction data 100 to the data communication module 2000 may be performed periodically (e.g., hourly, daily, weekly, monthly, quarterly, and the like). In one such embodiment, the transaction data 100 is communicated to the data communication module 2000 monthly. Monthly transaction data is preferred for more accurate data processing performed by the transaction processing module 3000. In another embodiment, the data communication module 2000 is configured to receive transaction data 100 automatically in real-time instead of periodically via any suitable communication method.

In addition, the data communication module 2000 is configured to receive transaction data 100 in multiple formats, such as, but not limited to, JSON, CSV, XML, and binary exports.

The data communication module 2000 can communicate the transaction data 100 to a data repository 5000 for storage (as shown in FIG. 3). The system 1000 or other external systems may access the transaction data 100 stored in the data repository 5000 for further upstream or downstream processes. In addition, the data communication module 2000 communicates the transaction data 100 to a unit module 3002 of a transaction processing module 3000 to divide and categorize the transaction data 100 into transactional base units prior to further processing by the transaction processing module 3000.

### The Transaction Processing Module

FIGS. 3-7 illustrate an example processing and calculation method performed by a transaction processing module 3000 according to an embodiment of the invention. Referring to FIG. 3, the data communication module 2000 communicates transaction data 100 to the transaction processing module 3000. In an alternative embodiment, transaction data 100 may be communicated to the transaction processing module 3000 directly instead of via the data communication module 2000.

### The Unit Module

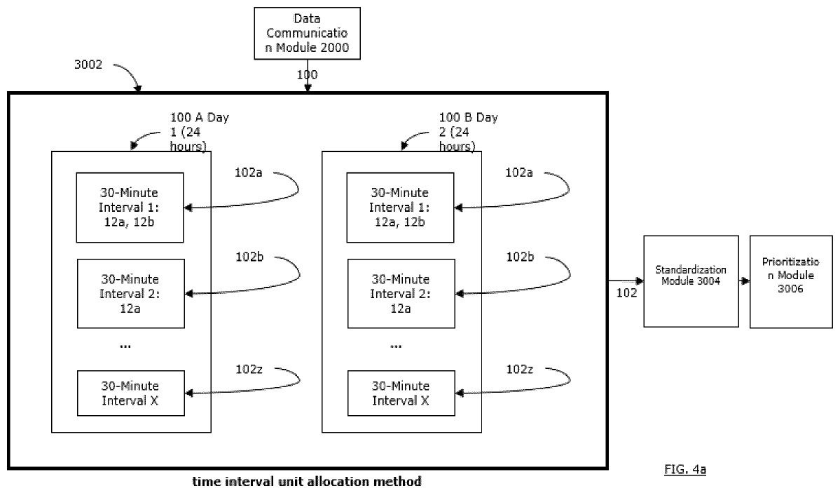

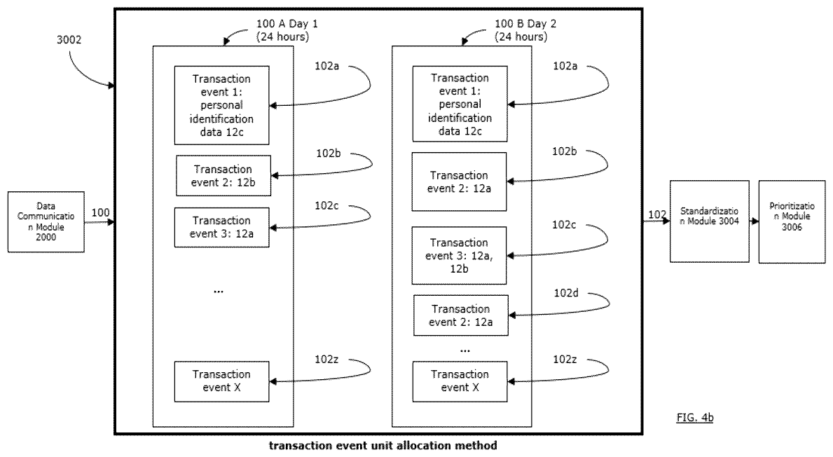

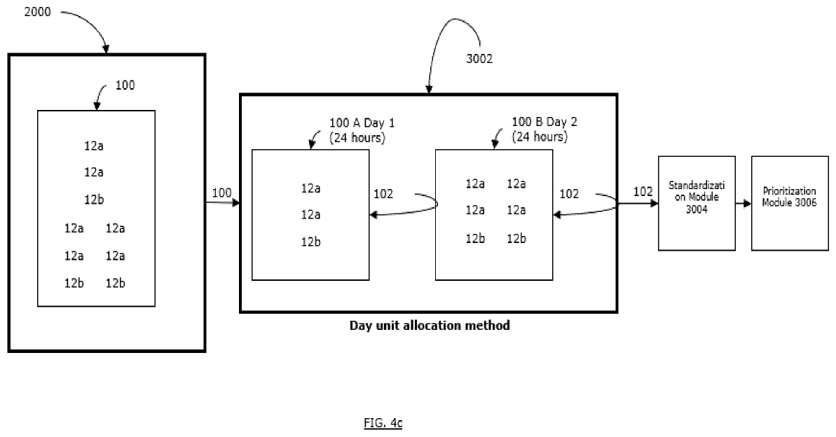

As discussed above, transaction data 100 is communicated to the data communication module 2000 periodically (e.g., daily, monthly, bi-monthly, etc.), preferably monthly. With continued reference to FIG. 3 and now referring now to FIGS. 4a-4c, a unit module 3002 of the transaction processing module 3000 divides transaction data 100 into daily batches, e.g., 24 hours (depicted as “100 A Day 1” and “100 B Day 2” in FIGS. 4 a-4c). In addition, the transaction data 100 within a specified day (e.g., Day 1 and Day 2) is then further divided into one or more transaction base units 102 (depicted as 102 or 102a, . . . , 102z). While transaction data 100 is ultimately treated as a single unit, the transaction processing module 3000 processes transaction data 100 as discrete transaction base units 102 to allow for more efficient and accurate processing. Such division of transaction data 100 into one or more transaction base units 102 can be done in one of three methods: (1) time interval unit allocation method, (2) transaction event unit allocation method, or (3) day unit allocation method.

As shown in FIG. 4a, under the time interval unit allocation method, each transaction base unit 102 represents a 30-minute interval. For instance, as shown, all data occurring during the first 30-minute interval of a Day 1 is associated to the first 30-minute base unit 102a interval of the day and so forth.

As shown in FIG. 4b, under the transaction event unit allocation method, each transaction base unit 102 corresponds to a transaction event instead of a fixed, static time interval, wherein a transaction event is a trigger, event, activity, or the like that triggers the creation of a generated category (12a, 12b) of transaction data. A new transaction event (e.g., IP address changes, network access events, facility badging, etc.) triggers the creation of a new transaction base unit 102. In such method, as shown in FIG. 4b, the unit module 3002 of the transaction processing module 3000 defaults the first transaction base unit 102a of a specific day (e.g., Day 1) to personal identification data 12c. When a transaction event, e.g., transaction event 2 (e.g., facility badging as shown in Day 1), is identified in the transaction data 100 for the specific day (e.g., Day 1), a new transaction base unit 102b is created and all data existing between the onset of the transaction event 2 and the identification of a subsequent transaction event, e.g., transaction event 3, are associated to transaction base unit 102b. If two or more transaction events occur simultaneously or an earlier transaction event remains active at the time a subsequent transaction event occurs, then the simultaneous transaction events are associated to a single transaction base unit 102 and the termination of one of the simultaneous transaction events triggers the creation of a new subsequent transaction base unit 102. The transaction base unit 102 representing simultaneous transaction events comprises all data existing between the onset of the simultaneous transaction events and the termination of one of the simultaneous transaction events. For instance, as shown in FIG. 4b, on Day 2, transaction event 3 occurs while transaction event 2 remains active, with the two transaction events overlapping until transaction 3 ends. Transaction base unit 102c represents all data existing between the start of the overlapping period and the termination of transaction event 3 and transaction base unit 102d represents all data associated to still-active transaction event 2 post termination of transaction event 3.

As shown in FIG. 4c, under the day unit allocation method, each transaction base unit 102 represents one day, e.g., 24 hours. The unit module 3002 of the transaction processing module 3000 does not further divide daily batches, e.g., 24 hours (depicted as “100 A Day 1” and “100 B Day 2” in FIG. 4c). For instance, as shown, all transaction data occurring during Day 1-12a, 12 a, and 12b—is associated to the Day 1 transaction base unit 102. Likewise, all transaction data occurring during Day 2 is associated to the Day 2 transaction base unit 102.

The unit module 3002 of the transaction processing module 3000 communicates one or more transaction base units 102 to the data repository 5000 for storage. The system 1000 or other external systems may access the transaction base units 102 stored in the data repository 5000 for further upstream and downstream processes. In addition, the unit module 3002 of the transaction processing module 3000 communicates one or more transaction base units 102 to a standardization module 3004 of the transaction processing module 3000 to standardize the transaction base units 102 to a certain schema for more efficient processing by subsequent modules and other external systems.

Once all of the individual transaction base units 102 have been processed by a standardization module 3004 and further by a prioritization module 3006 of the transaction processing module 3000 (discussed below), the unit module 3002 then consolidates the individual transaction base units 102 into a single dataset (e.g., daily, monthly, or any other custom period) and associates them to certain user records or device records for further processing (discussed below).

### The Standardization Module

The transaction data 100 received by the data communication module 2000 may be in multiple formats. Referring back to FIG. 3, a standardization module 3004 of the transaction processing module 3000 transforms each transaction base unit 102 by converting the transaction base unit 102 from its source format to a standardized format (the resulting standardized data described as “standardized transaction base unit” 104 herein). In an embodiment, this standardization is done by transforming values from their source format to a standardized schema using a maintained dictionary of source-to-canonical mappings.

In addition, the standardization module 3004 of the transaction processing module 3000 can tag each set of standardized transaction base unit 104 with certain data elements: (i) a unique but de-identified user reference that allows consistent tracking while protecting personal information; (ii) the precise time of the interaction expressed in a universal standard so events from different sources can be accurately sequenced; (iii) an indicator of the originating system or data feed; (iv) a category label that distinguishes between digital access data 12a, facility access credential data 12b, and identification data 12c; (v) a location reference that links the standardized transaction base unit 104 to a recognized physical site or jurisdiction; (vi) a measure of confidence that reflects the reliability of the location or category assignment; and (vii) a pointer back to the underlying source data to permit audit and verification. By producing standardized data, the system 1000 enables uniform categorization, prioritization, and downstream allocation regardless of the original source or format of the data.

If the standardization module 3004 of the transaction processing module 3000 is unable to standardize information within the source transaction base unit 102, then this information is not communicated to subsequent modules of the system 1000 for further processing and any external systems.

In addition, the standardization module 3004 of the transaction processing module 3000 transforms CRP names from their source format to a standardized format (e.g., “Sales Cloud Customer Management SaaS” to “Sales Cloud CRM”) and creates a CRP record 112 for each unique CRP identified. In an embodiment, this standardization is done by transforming CRP names from their source format to a standardized name. The CRP record 112 is then associated with each allocated record 108 found in the system 1000 (discussed below). Further, the standardization module 3004 assigns a contract classification for each CRP record 112. Contract classifications include, but are not limited to, an enterprise license, an application license, a seat license, or a platform as a service (PaaS) or infrastructure as a service (IaaS) license. Contract classifications may be determined by training a model of the standardization module 3004 to identify contract classifications.

The standardization module 3004 of the transaction processing module 3000 communicates standardized transaction base units 104 to the data repository 5000 for storage. The system 1000 or other external systems may access the standardized transaction base unit 104 stored in the data repository 5000 for further upstream and downstream processes. In addition, the standardization module 3004 of the transaction processing module 3000 communicates standardized transaction base unit 104 to a prioritization module 3006 of the transaction processing module 3000 to prioritize the categories (12a, 12b, and 12c) of transaction data associated with or within each set of standardized transaction base unit 104.

### The Prioritization Module

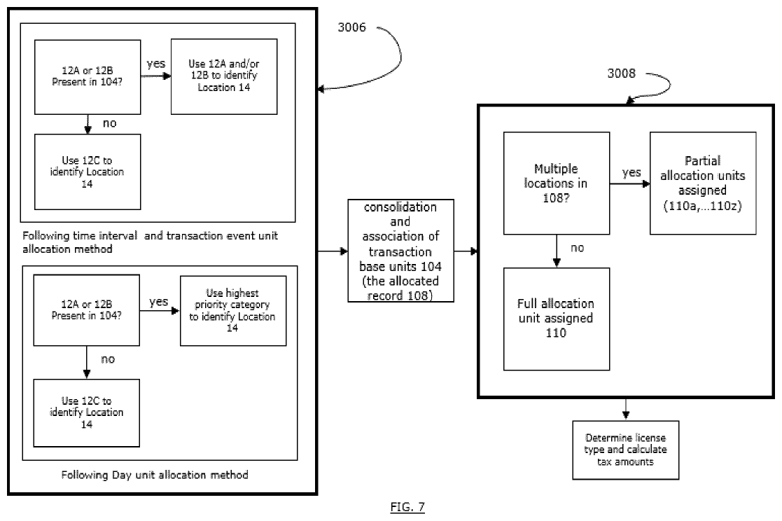

With continued reference to FIG. 3 and also referring to FIG. 7, a prioritization module 3006 of the transaction processing module 3000 prioritizes the categories (12a, 12b, 12c) of transaction data associated with or within a standardized transaction base unit 104. In addition, the prioritization module 3006 identifies a location 14 for the standardized transaction base unit 104 based on the transaction data category (12a, 12b, 12c) the prioritization module 3006 prioritized and captures a street address, municipality, state, and zip code for the location 14 identified.

Facility access credential data 12b, when available, provides the highest level of accuracy by linking a location 14 to authenticated access points. Digital access data 12a serves as an intermediate fallback, offering approximate interaction details when facility access credential data 12b is missing. Preferred forms of facility access credential information 12b from most preferred to least preferred include: (1) door or turnstile badge events emitted by an access controller that is mapped to a specific doorway and physical address as these events provide authenticated presence at a known point; (2) biometric reader events that are tied to a specific access controller and doorway; (3) mobile credentials such as NFC or RFID that are bound to a named reader and site; and (4) reception or kiosk check-ins that record presence but may not capture an actual door passage. Preferred forms of digital access data 12a from most preferred to least preferred include: (1) authenticated logins originating from a static corporate network segment that is pre-mapped to a site; (2) VPN concentrator session records with a concentrator location mapped to a site; (3) managed-device telemetry that provides coarse geolocation with a verified device identity; and (4) wireless access-point association logs that can be resolved to a site.

### Transaction Base Units that were Created via the Time Interval Unit Allocation Method or the Transaction Event Allocation Method

If a standardized transaction base unit 104 was created via the time interval unit allocation method or the transaction event unit allocation method (described above) and comprises only one generated category (12a, 12b) of transaction data—e.g., either digital access data or facility access credential information—then the prioritization module 3006 uses the location associated with the generated category (12a, 12b) of transaction data comprised in the data to identify and confirm a user's location 14 for the standardized transaction base unit 104 being processed.

If a standardized transaction base unit 104 was created via the time interval unit allocation method or the transaction event unit allocation method and comprises more than one generated category (12a, 12b) of transaction data—digital access data and facility access credential information—then the prioritization module 3006 of the transaction processing module 3000 prioritizes both facility access credential information 12b and digital access data 12a contained within the standardized transaction base unit 104 over personal identification data 12c, with a higher preference for facility access credential data 12b. When facility access credential information 12b and digital access data 12a are both present in a standardized transaction base unit 104, at least one form of digital access data 12a along with one form of facility access credential data 12b will be prioritized and used to identify and confirm a user's location 14 for the standardized transaction base unit 104 being processed. When facility access credential information 12b and digital access data 12a are both present in a standardized transaction base unit 104, the associated location is considered confirmed for the standardized transaction base unit 104 being processed if the location associated with the facility access credential information 12b and the location associated with the digital access data 12a fall within a defined geofence. If both locations are different, then the more preferred generated category (12a, 12b) of transaction data—facility access credential data 12b—is used. Any anomalies are flagged for review (e.g., to a downstream application user) and logged in an audit trail.

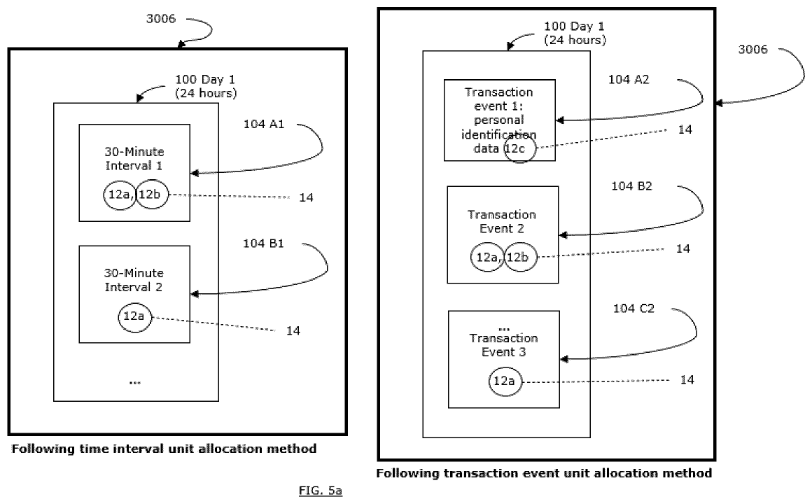

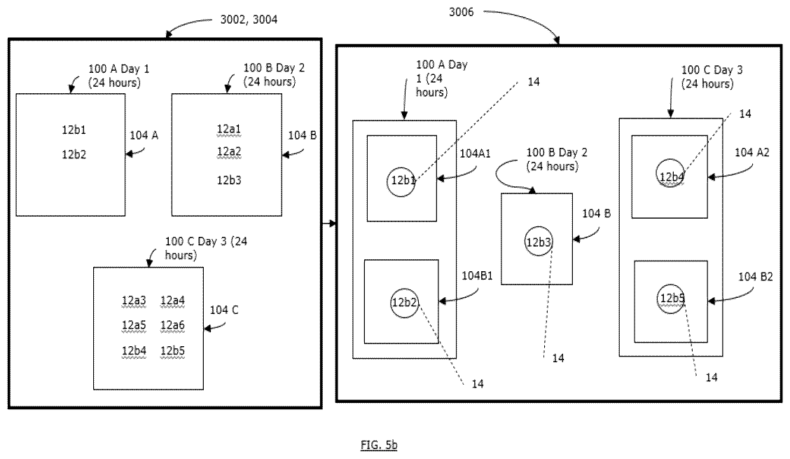

As a non-limiting example, illustrated in FIG. 5a (depending on which unit allocation method was followed), the prioritization module 3006 of the transaction processing module 3000 identified two generated categories of transaction data in standardized transaction base units 104 A1 and 104 B2: digital access data 12a and facility access credential data 12b. Since both facility access credential data 12b and digital access data 12a are present in the depicted transaction data, the prioritization module 3006 of the transaction processing module 3000 will prioritize these two categories (12a and 12b) over personal identification data 12c by using at least one facility access credential 12b data element (e.g., security badge) along with one digital access data 12a element (e.g., IP address) to identify and confirm a location 14 within the standardized transaction base unit 104 A. The prioritization module 3006 of the transaction processing module 3000 identified one category of transaction data in standardized transaction base unit 104 B1 and 104 C2: digital access data 12a. Since facility access credential data 12b is not present in the datasets but digital access data 12a is present in the depicted transaction datasets, the prioritization module 3006 of the transaction processing module 3000 will prioritize the digital access data 12a (e.g., IP address) over personal identification data 12c to identify a location 14 within the standardized transaction base unit 104 B1 and 104 C2.

If a standardized transaction base unit 104 was created via the time interval unit allocation method or the transaction event unit allocation method and does not comprise either generated category (12a, 12b) of transaction data—digital access data 12a or facility access credential information 12b—then the prioritization module 3006 of the preferred embodiment uses identification data 12c to determine a location 14 for the standardized transaction base unit 104 being processed, e.g., a user's HR assigned work location. Identification data 12c serves as a controlled fallback only when facility access and digital access data are absent from a standardized transaction base unit 104. In an embodiment, identification data 12c may be stored in the data repository 5000 and is retrieved by the prioritization module 3006.

### Standardized Base Units That Were Created via the Day Unit Allocation Method

If a standardized transaction base unit 104 was created via the day unit allocation method and comprises only one generated category (12a, 12b) of transaction data—e.g., either digital access data or facility access credential information—then the prioritization module 3006 uses the location associated with the generated category (12a, 12b) of transaction data comprised in the data to identify and confirm a location 14 for the standardized transaction base unit 104 being processed. For instance, standardized transaction base unit 104 comprises VPN data (digital access data 12a). The prioritization module 3006 uses the location associated with the VPN to identify and confirm a location 14 for the standardized transaction base unit 104. If a standardized transaction base unit 104 comprises two or more of the same generated categories (12a, 12b) of transaction data, then the prioritization module 3006 communicates the standardized transaction base unit 104 to the unit module 3002 of the transaction processing module 3000 to divide the transaction base unit 104 into two or more transaction base units 104 depending on how many of the same but unique generated categories (12a, 12b) of transaction data are present in the original standardized transaction base unit 104. For instance, as shown in FIG. 5b, day 1 transaction base unit 104 A comprises facility access credential information 12b1 for location 1, e.g., HQ, and facility access credential information 12b2 for location 2, e.g., satellite office. The prioritization module 3006 communicates the standardized transaction base unit 104 A to the unit module 3002 to divide the standardized transaction base unit 104 A into two separate transaction base units 104A1, 104B1, wherein the first standardized base unit 104A1 comprises all data existing up until the identification of the second facility access credential information data point 12b2 and the second standardized transaction base unit 104B1 comprises all data post identification of the second facility access credential information data point 12b2. The prioritization module 3006 uses the location associated with the generated category (12a, 12b) of transaction data present in the standardized transaction base unit 104A1, 104B1 to identify and confirm a location 14 for the standardized transaction base unit 104A1, 104B1 being processed.

If a standardized transaction base unit 104 was created via the day unit allocation method and comprises more than one generated category (12a, 12b) of transaction data—digital access data and facility access credential information—then the prioritization module 3006 of the transaction processing module 3000 prioritizes facility access credential information 12b over digital access data 12a to identify and confirm a location 14. If facility access credential information 12b is not present in a standardized transaction base unit 104, then the prioritization module 3006 prioritizes digital access data 12a. For instance, as shown in FIG. 5b, day 2 standardized transaction base unit 104 B comprises both digital access data 12a1, 12a2—VPN data and wireless access-point association data—and facility access credential information 12b3. Since facility access credential data 12b3 is present, the prioritization module 3006 prioritizes the facility access credential data 12b3 over the digital access data 12a1, 12a2 and uses the location associated with the facility access credential information 12b3 to identify and confirm a location 14 for the standardized transaction base unit 104 B. Essentially, the prioritization module 3006 uses the highest priority generated category (12a, 12b) of transaction data to determine the location 14 for a standardized transaction base unit 104. The prioritization module 3006 uses the location associated with the generated category (12a, 12b) of transaction data prioritized—12b3—in the standardized transaction base unit 104 B to identify and confirm a location 14 for the standardized transaction base unit 104 B. If a standardized transaction base unit 104 comprises two or more of the same but unique generated categories (12a, 12b) of transaction data and these generated categories (12a, 12b) of transaction data belong to the highest priority category of transaction data present in the standardized transaction base unit 104, then the prioritization module 3006 communicates the standardized transaction base unit 104 to the unit module 3002 of the transaction processing module 3000 to divide the transaction base unit 104 into two or more transaction base units 104 depending on how many unique, highest priority generated categories (12a, 12b) of transaction data are present in the original standardized transaction base unit 104. For instance, as shown in FIG. 5b, day 3 transaction base unit 104C comprises digital access data 12a3-12a6 and facility access credential data 12b4 for location 1, e.g., warehouse, and facility access credential information 12b5 for location 2, e.g., home office. Since facility access credential data is present, the prioritization module 3006 prioritizes the facility access credential data 12b4, 12b5 over digital access data 12a3-12a6. However, since two unique facility access credential data 12b4, 12b5 points exist and both belong to the highest priority category of transaction data present in the standardized transaction base unit 104 C, the prioritization module 3006 communicates the standardized transaction base unit 104 C to the unit module 3002 to divide the standardized transaction base unit 104 C into two separate transaction base units 104 A2, 104 B2, wherein the first standardized base unit 104 A2 comprises all data existing up until the identification of the second facility access credential information data point 12b5 and the second standardized transaction base unit 104 B2 comprises all data post identification of the second facility access credential information data point 12b5. Likewise, if transaction base unit 104 C comprised only digital access data 12a3-12a6, then the prioritization module 3006 would communicate the standardized base unit 104 C to the unit module 3002 to divide the standardized transaction base unit 104 C into four separate standardized transaction base units 104 because there are four digital access data 12a3-12a6 points present in the standardized transaction base unit 104 C and these data points belong to the highest priority category of transaction data present in the standardized transaction base unit 104 since higher priority facility access credential data 12b was not present in the standardized transaction base unit 104 C. For each standardized transaction base unit 104 A2, 104 B2, the prioritization module 3006 uses the location associated with the generated category (12a, 12b) of transaction data prioritized—12b4 and 12b5—to identify and confirm a location 14 for the standardized transaction base unit 104 A2, 104 B2.

If a standardized transaction base unit 104 was created via the day unit allocation method and does not comprise either generated category (12a, 12b) of transaction data—digital access data 12a or facility access credential information 12b—then the prioritization module 3006 of the preferred embodiment uses identification data 12c to determine a location 14 for the standardized transaction base unit 104 being processed, e.g., a user's HR assigned work location. Identification data 12c serves as a controlled fallback only when facility access and digital access data are absent from a standardized transaction base unit 104. In an embodiment, identification data 12c may be stored in the data repository 5000 and is retrieved by the prioritization module 3006.

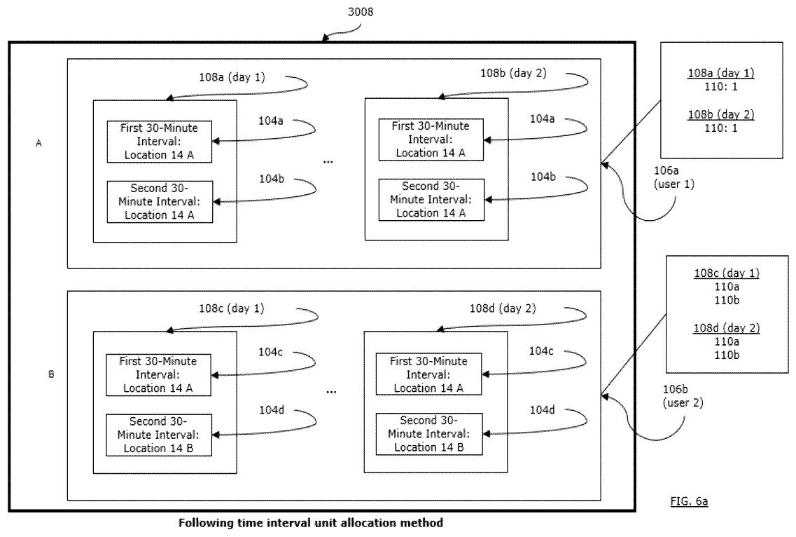

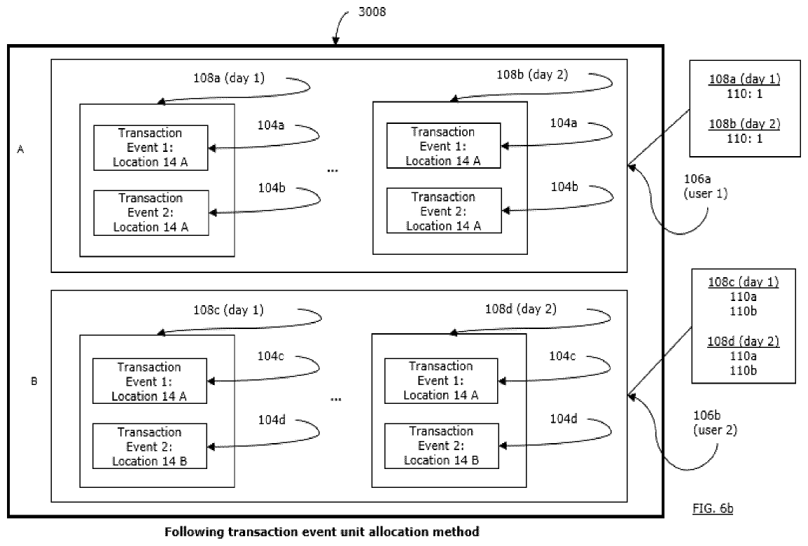

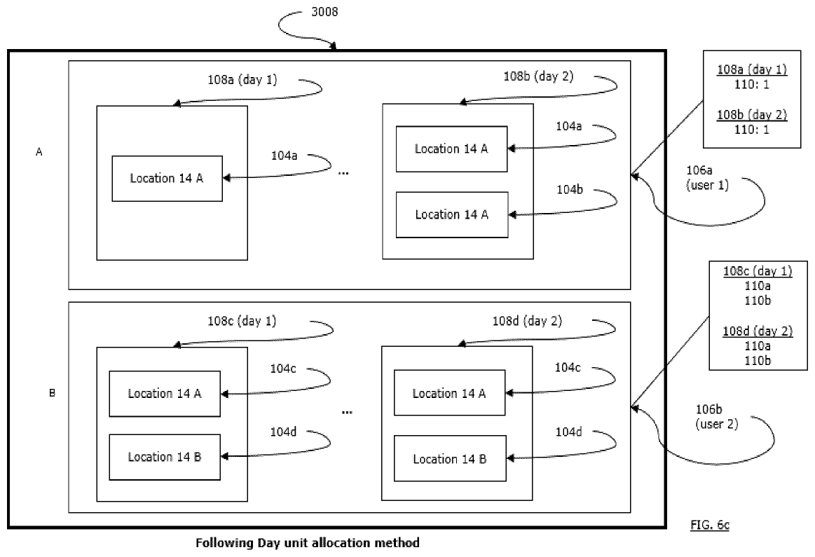

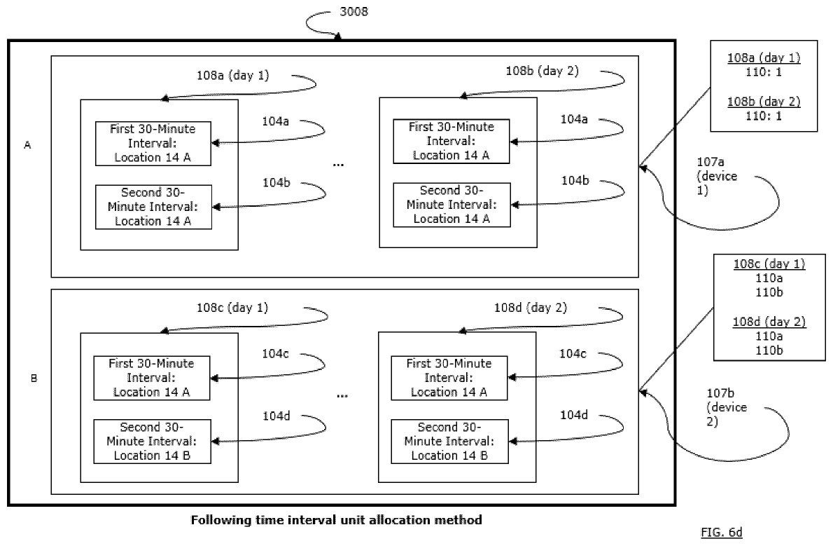

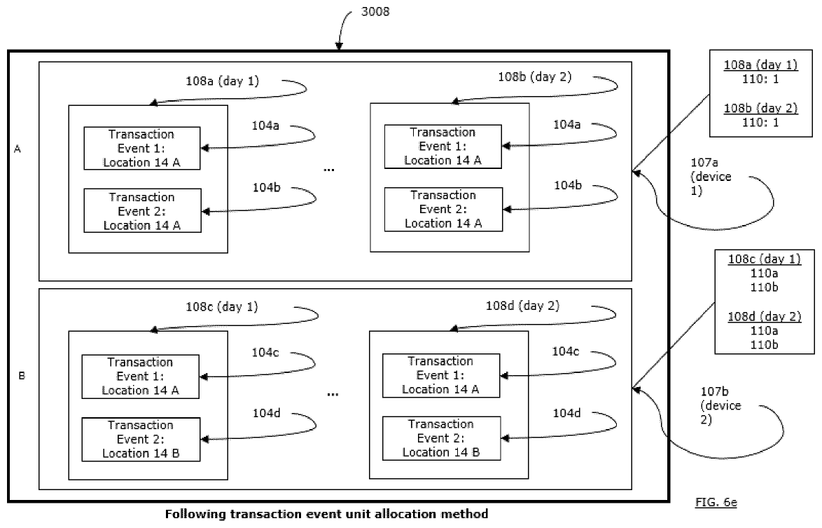

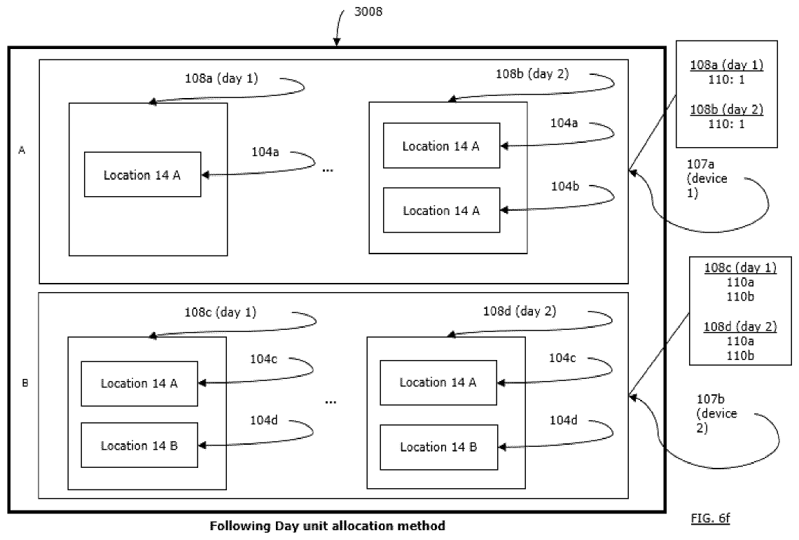

Referring back to FIG. 3 and now referring now to FIGS. 6a-6f, once the prioritization module prioritizes the categories (12a, 12b, 12c) of transaction data and identifies a location 14 for each standardized transaction base unit 104, the unit module 3002 of the transaction processing module 3000 consolidates and associates all of the standardized transaction base units 104 from over a single day to a specific user record 106 or a device record 107 (the consolidated and associated transaction base units 104 described as “allocated data,” “allocated dataset,” or “allocated record” 108 herein). As a non-limiting example, shown in FIGS. 6a-6c (depending on which unit allocation method was followed), allocated record 108a associated with a first user 106a comprises standardized transaction base units 104a and/or 104b from over a single day. As shown, even though allocated record 108a may comprise multiple standardized transaction base units (as shown in FIGS. 6a and 6b), each of these standardized transaction base units are associated to the same location—location A. As such, allocated record 108a comprises only one location 14 (e.g., Location 14 A). Similarly, allocated record 108c associated with a second user 106b comprises standardized transaction base units 104c and 104d from over a single day. As shown, allocated record 108c comprises two locations 14 (e.g., Location 14 A and Location 14 B). By consolidating and associating all of the standardized transaction base units 104 to a specific user record 106, a location unit module 3008 of the transaction processing module can allocate full or partial units for each location identified in an allocated record 108. In addition, as a non-limiting example, as shown in FIGS. 6d-6f (depending on which allocation method was followed), standardized transaction base units 104 may be associated to a device record 107 instead of a user record 106. For instance, a device comprising a CRP can be shared between multiple employees and thus a company may prefer to track the locations associated with the device instead of the employees. As shown in FIGS. 6d-6f, allocated record 108a associated with a first device 107a comprises standardized transaction base units 104 104a and/or 104b from over a single day. As shown, allocated record 108a comprises only one location 14 (e.g., Location 14 A). Similarly, allocated record 108c associated with a second device 107b comprises standardized transaction base units 104c and 104d from over a single day. As shown, allocated record 108c comprises two locations 14 (e.g., Location 14 A and Location 14 B). By consolidating and associating all of the standardized transaction base units 104 to a specific device record 107, a location unit module 3008 of the transaction processing module can allocate full or partial units for each location identified in an allocated record 108.

The resulting allocated data 108 may comprise multiple locations. For instance, the prioritization module 3006 may have identified Chicago as a user location 14 for a first standardized transaction base unit 104 and Indianapolis as a user location 14 for a second standardized transaction base unit 104 found within an allocated dataset 108 associated to the user record 106 or device record 107. Multi-location work is becoming more prevalent with technological advancements, globalization, and shifting employee preferences for remote work. As a result, a user (e.g., an employee) may need to interact with a CPR from multiple locations in a single day. A subsequent location unit module 3008 of the transaction processing module 3000 allocates full or partial units for each identified location within the allocated data 108 (described below).

The prioritization module 3006 of the transaction processing module 3000 communicates an allocated record 108 to the data repository 5000 for storage. The system 1000 or other external systems may access allocated records 108 stored in the data repository 5000 for further upstream and downstream processes. In addition, the prioritization module 3006 of the transaction processing module 3000 communicates allocated records 108 to a location unit module 3008 of the transaction processing module 3000 to allocate full or partial units for each identified location 14 within the allocated record 108.

### The Location Unit Module

The location unit module 3008 of the transaction processing module 3000 can identify any number of locations within the allocated record 108 associated to a user record 106 or device record 107 and as discussed further below a computation module 3014 of the transaction processing module 3000 can accommodate tax computation between more than two locations. The location unit module 3008 of the transaction processing module 3000 performs the same method steps in the same manner for each location identified in an allocated record 108.

The location unit module 3008 of the transaction processing module 3000 allocates units 110 for each location 14 identified in an allocated record 108. Referring to FIG. 7, based on the number of locations 10 identified, the location unit module 3008 of the transaction processing module 3000 will assign either full 110 or partial units (110a, . . . , 110z). As shown in FIG. 7, when the location unit module 3008 of the transaction processing module 3000 identifies multiple locations in an allocated record 108, the location unit module 3008 of the transaction processing module 3000 assigns partial allocation units 110a, . . . , 110b to each identified location. If the location unit module 3008 of the transaction processing module 3000 identifies one location in an allocated record 108, then the location unit module 3008 of the transaction processing module 3000 assigns a full allocation unit 110 to the identified location. In an embodiment, a full allocation unit 110 represents an eight-hour day, while partial units (110aa, . . . , 110z) are derived as fractions of the eight-hour day. The total allocation units 110 for each allocated record 108 (whether as a full or partial allocation unit) are accumulated over a taxable period (preferably one month or another period) by the location unit module 3008. As a non-limiting example, illustrated in FIGS. 6a-6f, when following path A, the location unit module 3008 of the transaction processing module 3000 allocates full units 110 since only one location, e.g., Location 14 A, was identified in the allocated record 108 associated to a user record 106a or device record 107a. Further, when following path B, the location unit module 3008 of the transaction processing module 3000 assigns partial units 110a for location 14 A and partial units 110b for location 14 B since multiple locations, e.g., Locations A and B, were identified in the allocated record 108 associated to a user record 106b or device record 107b. Where both facility access credential data 12b and digital access data 12a (e.g., on vacation days, sick days, holidays, or other days with usage absences) are absent from the allocated record 108 and thus no location 14 is identified, the location unit module 3008 of the transaction processing module 3000 processes identification data 12c, such as assigned office location or home state, to estimate allocation units 110 for the allocated data 108. In an embodiment, personal identification data 12c may be stored in the data repository 5000 and is retrieved by the location unit module 3008.

### The Validation Module

Referring back to FIG. 3, if the location unit module 3008 of the transaction processing module 3000 assigns partial allocation units (110a, . . . , 110z) to an allocated record 108, a validation module 3010 of the transaction processing module 3000 validates the assigned partial allocation units (110a, . . . , 110z) of the allocated record 108 to ensure accuracy of the assigned units. The validation module 3010 of the transaction processing module 3000 may perform the following verification checks and measures: a temporal consistency check, a geospatial feasibility check, a policy compliance validation. If the location unit module 3008 of the transaction processing module 3000 does not assign partial allocation units (110a, . . . , 110z), then the validation module 3010 of the transaction processing module 3000 does not validate the assigned allocation units of the allocated record 108. The validation module 3010 performs these checks and measures to strengthen the reliability of the system 1000, specifically the allocation performed by the location unit module 3008 of the transaction processing module 3000, ensuring the process is accurate and logical. Further, performing such checks also minimizes errors and provides a framework for downstream application users and processes to address anomalies.

The validation module 3010 of the transaction processing module 3000 may perform a temporal consistency check to verify that the total sum of the partial allocation units (110a, . . . , 110z) within an allocated dataset 108 does not exceed the logical maximum for the specified time period. For instance, the temporal consistency check of the validation module 3010 sums location 1 units 110 a with location 2 units 110 b to ensure such sum does not exceed 24 hours. Similarly, weekly interactions are checked against a maximum of 168 hours, and longer periods are validated proportionately. Any anomalies identified by the temporal consistency check of the validation module 3010, such as totals exceeding these thresholds, are flagged for review (e.g., to a downstream application user), logged in an audit trail generated by the validation module 3010, and/or corrected using predefined error-handling protocols.

The validation module 3010 of the transaction processing module 3000 may perform a geospatial feasibility check to confirm that the identified locations 14 within an allocated dataset 108 are physically plausible within the given time constraints. This involves calculating the geographic separation between consecutive locations 14 and comparing it to predefined travel time constraints, e.g., using great-circle distance or time-distance heuristics. For instance, if two locations, e.g., location 1 and location 2, are identified in an allocated record 108, the geospatial feasibility check of the validation module 3010 verifies that such a transition is feasible given the distance and available means of transport by using algorithmic travel time approximations based on predefined speed thresholds (e.g., 60 mph) and geographic constraints (e.g., terrestrial or non-terrestrial). Any anomalies identified by the geospatial feasibility check of the validation module 3010 are flagged for review (e.g., to a downstream application user) and logged in the audit trail generated by the validation module 3010 for review, ensuring transparency. In addition, when facility access and digital access data disagree within an infeasible travel window, the validation module 3010 of the transaction processing module 3000 may give priority to the facility access data instead.

The validation module 3010 of the transaction processing module 3000 may perform a policy compliance validation by cross-referencing each identified location in an allocated record 108 against a predefined list of authorized locations. If an identified location 14 occurs at an unauthorized location, the system flags this anomaly for downstream administrator review by the application user, logged in the audit trail generated by the validation module 3010, and/or applies any default tax allocation policy as defined by the system 1000 governing parameters.

In addition, the validation module 3010 of the transaction processing module 3000 generates an audit trail to ensure transparency and facilitate downstream analysis. An audit trail logs key metrics, such as flagged temporal inconsistencies, geospatial verifications, and policy compliance checks. The validation module 3010 communicates an audit trail to the data repository 5000. The data repository 5000 stores the audit trail for compliance purposes and use by downstream application users. In addition, the validation module 3010 of the transaction processing module 3000 communicates an audit trail to the user interface 4000 for an application user to view and interact with such information in real time. Further, an audit trail and underlying transaction data contained within the audit trail are securely stored in a tamper-evident format, to enhance compliance with regulatory requirements. An audit trail may also include interaction logs, validation results, and metadata timestamps that capture the creation, modification, and access events, and tax allocation calculations. Furthermore, an audit trail supports seamless export functionality, enabling integration with external regulatory filing systems or audit review platforms, thereby enhancing transparency and operational efficiency.

With continued reference to FIG. 3, once the location unit module 3008 of the transaction processing module 3000 allocates units 110 for each identified location 14 within an allocated record 108 and the validation module 3010 of the transaction processing module 3000 validates the assigned units (if partial units are identified), a contract classification module 3012 of the transaction processing module 3000 assigns a contract classification and taxing authority location for each allocation unit 110 (or 110a, . . . , 110z) of an allocated dataset 108. Such assignment is done first by associating a CRP record 112 to an employee record 106 or device record 107. The CRP record 112 comprises employee and device information. The contract classification module 3012 of the transaction processing module 3000 associates a CRP record 112 to an employee record 106 or device record 107 if the employee record 106 or device record 107 have the same employee and/or device information found under the CRP record 112. In an embodiment, for instance, the contract classification module 3012 of the transaction processing module 3000 associates a CRP record 112 to an employee record 106 or device record 107 by first trying to match an employee ID found under both records, followed by email, and then by name if no employee ID or email exist. Multiple CRP records 112 may be associated to a single employee record 106 or device record 107 if an employee or device interacts with multiple CRPs. Then, the contract classification found under the CRP record 112 is the contract classification assigned to a particular allocation unit 110 found under an allocated record 108 associated to an employee record 106 or device record 107. In most instances, a CRP is classified as an enterprise license, an application license, a seat license, or a PaaS or IaaS license. As known to those skilled in the art, enterprise licenses generally grant an organization the right to authorize all individual users and devices within the enterprise the ability to interact with a CRP at a flat rate or negotiated price. Application licenses, sometimes referred to as function licenses, are generally applied to specific software applications related to special operations within an organization. For example, engineering functions may have a license to a specific computer aided design (CAD) CRP for members of that function while other employees do not have the ability to interact with the CAD CRP. Finally, seat licenses are generally related to one-off licenses used by relatively few members of, or devices used by, an organization. For example, seat licenses might be used by a select few organization members in a legal function who need access to legal research CRPs or video editing workstations' CRPs used by marketers.

Once the contract classification module 3012 associates a CRP record 112 to an employee record 106 or device record 107 and assigns a particular contract classification to an allocation unit 110 found under an allocated record 108 associated to the employee record 106 or device record 107, then the contract classification module 3012 determines a taxing authority location based on the assigned contract classification for the allocation unit 110. Depending on the taxing authority, different types of licenses may carry different tax liabilities.

For an application license or seat license the contract classification module 3012 sets the taxing authority location to the location 14 associated with the allocation unit 110 being processed to calculate tax obligations. For instance, using the exemplary allocated records 108 set forth in FIGS. 6a-6f, CRP record 112 comprises data for a Sales SaaS and is associated to allocated records 108a and 108c. If the assigned contract classification for the Sales SaaS is either an application license or a seat license, then the contract classification module 3012 sets the taxing authority location to the location 14 associated with the allocation units found under the allocated record 108 a, 108c—Location 14 A and Location 14 B.

For enterprise licenses, the contract classification module 3012 of the transaction processing module 3000 sets the taxing authority location to either a state sourcing address or the location 14 associated with the allocation unit 110 being processed. The sourcing address is typically based on the location of the organization's highest populated office or other significant operational source point, as identified through human resources (HR) data or equivalent records. This means, when using the sourcing address, the location used for computing tax obligations is not the identified locations 14 but the sourcing address associated with the CRP record 112.

### The Computation Module

With continued reference to FIG. 3, a computation module 3014 of the transaction processing module 3000 calculates one or more tax amounts. Once the contract classification module 3012 of the transaction processing module 3000 identifies the relevant taxing authority location for each location and applies the appropriate tax rate based on the CRP's license type, the computation module 3014 of the transaction processing module 3000 calculates one or more tax amounts. The classification of the CRP—whether as an enterprise license, application license, seat license, or another category—affects the tax liability calculation. For example, enterprise licenses typically incur a flat-rate tax across all interactions, while application and seat licenses may incur location-specific rates. This comprehensive approach ensures that the tax calculation accounts for both geographic and contractual variables.

The computation module 3014 of the transaction processing module 3000 calculates the total contract value subject to tax by determining the aggregate licensing cost and applying a weighted percentage allocation by state. This percentage is derived from the collective individual identification base, including employee headcount and residency data, as maintained by the relevant recordkeeper. By considering the proportional distribution of users across states, the transaction processing module 3000 ensures accurate apportionment of tax liabilities to each jurisdiction, reflecting the operational and economic footprint of the enterprise license. Similar variations apply for application licenses and seat licenses. Other less common license types, such as usage-based, feature-based, device-based, token-based, time-based, and so forth, are contemplated by this disclosure. For example, for usage-based licenses, the system 1000 calculates taxes proportionate to interaction volume (e.g., data transmitted or features accessed), while feature-based licenses incur location-specific tax rates, as they apply to specialized software functions used by designated teams. These and other variations are known to those of skill in the art.

In an embodiment, in cases where transaction data 100 is provided by third-party recordkeepers, the system 1000 communicates with these external systems to access and process relevant transaction data 100. This integration ensures that third-party data, such as employee headcount and residency details, is validated and utilized alongside internal records to ensure accurate tax apportionment. In such an embodiment, cross-verification mechanisms are employed to compare transaction data 100 from internal and third-party sources, minimizing discrepancies and maintaining data integrity.

In an embodiment, when accommodating adjustments for CRP users who are non-U.S. employees or contractors, the transaction processing module 3000 includes a special employee calculation step. This step applies jurisdiction-specific rules or exemptions for CRP users who are employees and contractors based outside the U.S., such as regional tax treaties, reciprocal agreements, or local tax regulations. The special employee calculation ensures that these adjustments are integrated into the overall tax allocation process, reflecting the global operational footprint of the enterprise. For instance, contractors working in jurisdictions with VAT-based systems may incur different tax liabilities compared to employees in U.S. states with sales tax.

The computation module 3014 of the transaction processing module 3000 may calculate a total CRP tax amount. The total CRP tax amount is the total tax cost for a specific CRP. This calculation is done by summing the tax amount of every employee record 106 or device record 107 associated with the certain CRP. For instance, if employee records 106 A, B, and C are associated with CRP record 112 “CloudSource,” then the computed tax amount for employee records 106 A, B, C with respect to CloudSource are summed to determine a company's total CRP tax amount for CloudSource.

The computation module 3014 of the transaction processing module 3000 may calculate a total state tax amount. The total state tax amount is the total tax obligation a company has for a specific state. This calculation is done by summing the tax amount of every employee record 106 or device record 107 associated with the specific state. For instance, if employee records 106 A, B, and C are associated with location 14 “Illinois,” then the total tax obligations of each of these employee records 106 A, B, C are summed to determine a company's total tax obligations for Illinois regardless of CRP type.

The computation model 3014 of the transaction processing module 3000 includes a pointer back to the underlying source data for each computation performed to permit audit and verification.

In embodiments, the unit module 3002, the standardization module 3004, the prioritization module 3006, the location unit module 3008, the validation module 3010, the contract classification module 3012, and computation module 3014 of the transaction processing module 3000 may be structured as a single module performing multiple functions, or as distinct modules, each performing a certain functionality. The foregoing modules of the transaction processing module 3000 are described separately herein for clarity and to highlight each module's distinct function.

### The MPU User Interface

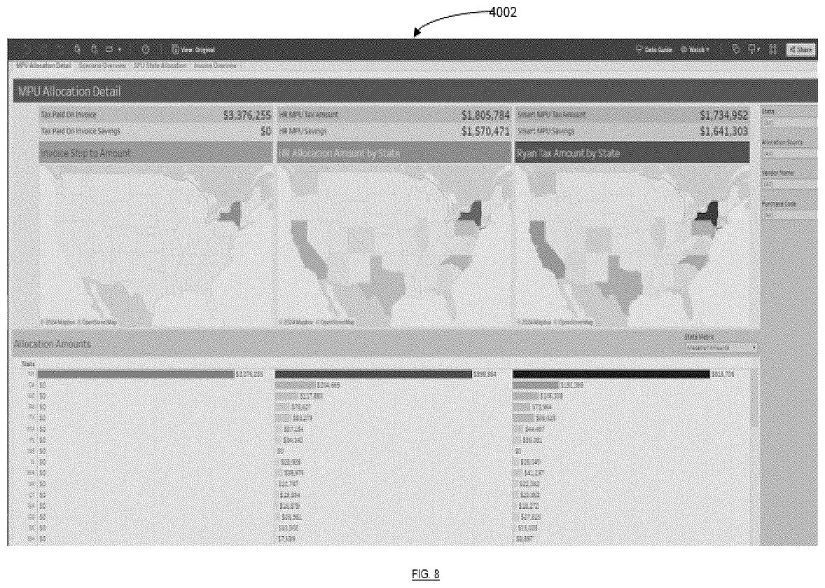

Referring now to FIGS. 8-11, exemplary screens of a user interface 4000 for application users to view and interact with the transaction output of the transaction processing module 3000, e.g., transaction units 102, 104, allocated record 108, units 110, anomalies, audit trail, computed tax data, and the like are shown according to an embodiment of the invention.

FIG. 8 illustrates an exemplary allocation screen 4002 of the user interface 4000 comprising a tax paid on invoice section, an HR MPU tax amount section, and a smart MPU tax amount section. Further, the allocation screen 4002 comprises various allocation amounts. The tax paid on invoice section shows tax paid on invoice using ship-to sourcing; the HR MPU tax amount section shows HR-based MPU allocation; the MPU tax amount section shows Smart MPU (validated allocation). The lower tables show allocation or tax amounts by state and allow filters by vendor, state, allocation source, and purchase code. The allocation screen 4002 of the user interface 4000 demonstrates the improvement from static to validated allocation.

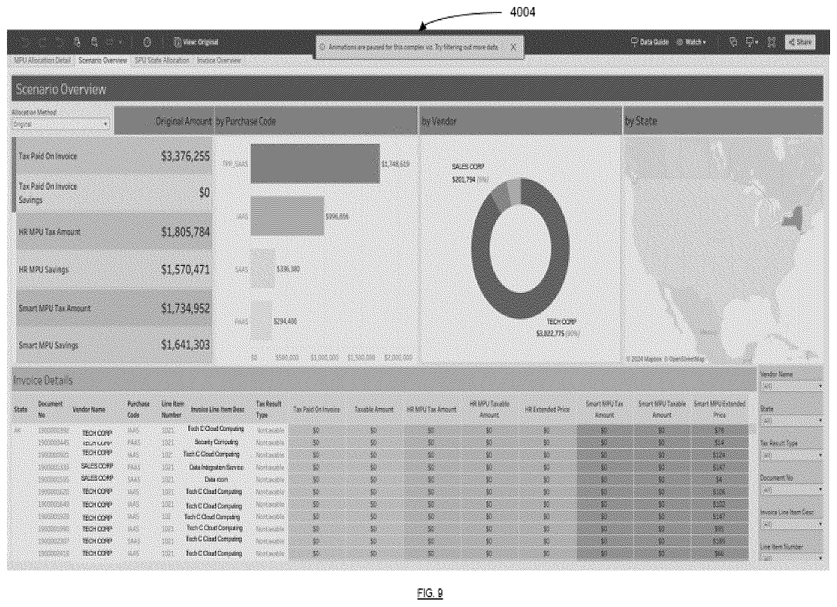

FIG. 9 illustrates an exemplary MPU scenario and overview screen 4004 of the user interface 4000 comprising sections including, but not limited to, invoice details, taxes by purchase code, taxes by vendor, taxes by state. The taxes by vendor section displays the amount of taxes due to the vendor. For instance, $201,794 is due to Sales Corp. The taxes by state section displays the amount of taxes due in that state. For instance, New York is highlighted green to indicate that taxes are due in New York.

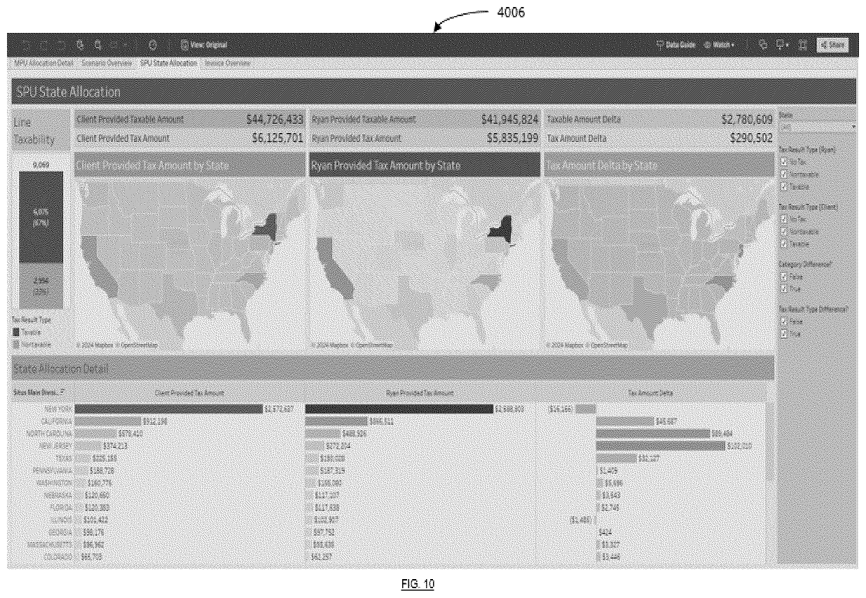

FIG. 10 illustrates an exemplary MPU allocation screen 4006 of the user interface 4000 comprising a client-provided tax amount by state section, a tax amount computed by the system 1000 by state section, tax amount delta by state section, and a state allocation detail section. The tax amount delta by state section displays the difference between the client-provided tax amount by state and the tax amount computed by the system 1000 by state. For instance, for California, the client-provided tax amount by state is $912,189 and the tax computed by the system 1000 by state is $488,926. The difference between both is listed in the tax amount delta by state, which is $45,687.

### Other Applications

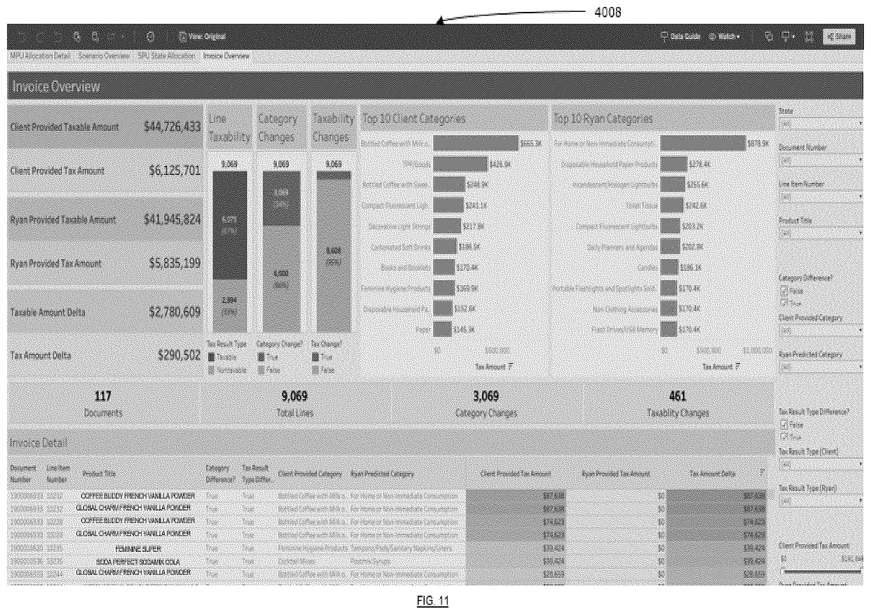

While the system 1000 has been developed for MPU tax computations, the system 1000's architecture and functionality of its accompanying modules are broadly applicable. The modules disclosed herein can support a variety of allocation and computation scenarios beyond the originally intended domain. For instance, the transaction processing module 3000 of the system 1000 can allocate for expense-related items that are tied to employee headcount. For instance, if a company is buying cleaning supplies, then the company may want to allocate based upon actual presence of employees in a physical location versus an HR location table. If an employee is coded as a New York employee in an HR table but really is working from home in New Jersey, the company can leverage the existing system 1000 to allocate the employee's location to New Jersey rather than New York. FIG. 11 illustrates an exemplary screen of an alternative allocation and computation scenario. Specifically, FIG. 11 depicts totals for client taxable amount, system-calculated 1000 taxable amount, the delta, and the resulting tax amount delta. The next three visuals display line-level taxability and category changes, and the top categories driving the differences. The lower grid ties each invoice document and line to the client-provided category and tax amount, predicted category and tax amount computed by the system 1000, and the delta; this supports audit and variance review.

Although the present invention and its advantages have been described in detail, it should be understood that various changes, substitutions, and alterations can be made herein without departing from the spirit and scope of the invention as defined in the appended claims.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for analyzing and allocating multi-point usage tax associated for a computing resource platform (CRP), wherein the CRP is used at one or more locations, the method comprising:
receiving transaction data, comprising at least one of the following transaction data type categories: (a) identification data for an individual or device, (b) digital access data associated with the individual's interaction with the CRP at the one or more locations, (c) facility access credential data associated with the individual use of a facility access credential to access one or more locations;
dividing the transaction data into one or more transactional base units;
standardizing each of the one or more transactional base units into a common format;
identifying a location within one or more transactional base units based on the following hierarchy:
(1) if the transactional base unit includes facility access credential data, using the facility access credential data to identify the location of the individual accessing the CRP and determining the amount of time attributed to the individual at the location;
(2) if the transactional base unit lacks facility access credential data, then using digital access data to identify a location of the individual accessing the CRP and determining the amount of time attributed to the individual at the location;
(3) if the transactional base unit lacks facility access credential data and digital access data, then using identification data where the identification includes an assigned location for the individual or the device and determining the amount of time attributed to the individual or device at the assigned location;
consolidating all of the transactional base units for a given day and associating the consolidated transactional base units for a given day to an allocated record for a user or device;
allocating full allocation units or partial allocation units for each identified location in the allocated record,
wherein if only one location is identified in the allocated record, then assigning full allocation units to the identified location in the allocated record;
wherein if one or more locations are identified in the allocated record, then assigning partial allocation units to each of the one or more locations identified in the allocated record, wherein the partial allocation units amount corresponds to the amount of time attributed to the individual at each of the one or more locations identified in the allocated record;
validating the allocated record;
associating the allocated record for the user or the device with a CRP record, wherein the CRP record comprises a licensing model associated with the CRP;
identifying a taxing authority location corresponding to each location identified in the allocated record and an applicable usage tax rate for each location; and
calculating a total tax applicable to each location using the full allocation units and partial allocation units and the applicable usage tax rate for each location to allocate a multi-point usage tax based on the amount of time attributed to a plurality of individuals associated with the locations.

2. The method of claim 1, wherein said division into one or more transactional base units comprises using one of the following division methods: (1) time interval unit allocation method, (2) transaction event unit allocation method, or (3) day unit allocation method.

3. The method of claim 1, wherein standardizing each of the one or more transactional base units further comprises including at least one of the following: a user reference, a time of occurrence, a source indicator, a category label distinguishing personal identification, digital access data, and facility access credential data, and a location reference.

4. The method of claim 1, wherein the licensing model is selected from a group comprising: an enterprise software system, an application-based software system, and a seat license system.

5. The method of claim 1, wherein the validating step comprises performing one or more of the following validations:
verifying one or more of the following:
the total allocated time does not exceed a logical maximum for the time period;
the geospatial feasibility between consecutive interaction locations using a distance-over-time criterion;
confirming that each interaction location is an authorized location; and
generating an audit trail of validation results.

6. The method of claim 5, wherein the validating step further comprises assigning a confidence score to the allocated record based on application of the validations.

7. The method of claim 5, wherein the audit trail associates the tax calculation with the allocated record and its associated data.

8. A system for allocating multi-point usage tax associated with a computing resource platform (CRP), wherein the CRP is used at one or more locations, the system comprising:
a data communication module configured to receive transaction data from the CRP wherein the transaction data comprises at least one of the following transaction data type categories: (a) identification data for an individual or device, (b) digital access data associated with the individual's interaction with the interactive software platform at the one or more locations, (c) facility access credential data associated with the individual use of a facility access credential to access one or more locations;
a data repository; and
a transaction processing module configured to receive the transaction data from the data communication module, and wherein the transaction processing module is configured to send one or more of the transaction data, a standardized transactional base unit and an allocated record to the data repository, and wherein the transaction processing module is further configured to:
(i) divide the transaction data into one or more transactional base units;
(ii) standardize each of the one or more transactional base units into a common format;
(iii) identify a location within each of the one or more transactional base units based on the following location determination hierarchy:
(1) if the transactional base unit includes facility access credential data, then the transaction processing module uses the facility access credential data to identify the location of the individual accessing the CRP and the transaction processing module determines the amount of time attributed to the individual at the location;
(2) if the transactional base unit lacks facility access credential data, then the transaction processing module uses digital access data to identify the location of the individual accessing the CRP and the allocation module determines the amount of time attributed to the individual at the location;
(3) if the transactional base unit lacks facility access credential data and digital access data, then the transaction processing module uses identification data for the individual or device where the identification data includes an assigned location for the individual or device and the transactional processing module determines the amount of time attributed to the individual or the device at the assigned location;
(iv) consolidate all of the transactional base units for a given day and associating the consolidated transactional base units for a given day to an allocated record for a user or device;
(v) allocate full allocation units or partial allocation units for each identified location in the allocated record, wherein if only one location is identified in the allocated record, then assigning full allocation units to the identified location in the allocated record, and wherein if one or more locations are identified in the allocated record, then assigning partial allocation units to the each of the one or more locations identified in the allocated record, wherein the partial allocation amount corresponds to the amount of time attributed to the individual at each of the one or more locations identified in the allocated record;
(vi) validate the allocated record;
(vii) associate the allocated record for the user or the device with a CRP record associated with the licensing model for the CRP;
(viii) identify a taxing authority corresponding to each location and an applicable usage tax rate for each location; and
(ix) calculate the total tax applicable to each location using the full allocation units and partial allocation units and the applicable usage tax rate for each location to allocate a multi-point usage tax based on the amount of time attributed to a plurality of individuals associated with the locations.

9. The system of claim 8 further comprising a user interface configured to display an output of tax computations from the transaction module.

10. The system of claim 8 wherein the transaction module further comprises one or more of a unit module configured to divide transaction data into one or more transactional base units, a standardization module configured to standardize the one or more transactional base units, a prioritization module configured to apply a hierarchical transaction data category analysis and identify a location within a standardized transactional base unit and consolidate one or more standardized transactional base units to an allocated record, a location unit module to allocate full or partial units to one or more locations identified within the allocated record, a validation module configured to validate the allocated record, a contract classification module configured to assign a contract classification for each allocation unit within the allocated record, or a computation module configured to calculate the total tax applicable to each location.

11. The system of claim 8, wherein said division of transaction data into one or more transactional base units comprises using one of the following division methods: (1) time interval unit allocation method, (2) transaction event unit allocation method, or (3) day unit allocation method.

12. The system of claim 8 wherein the standardized transaction data comprises at least a user reference, a time of occurrence, a source indicator, a category label distinguishing personal identification, digital access data, and facility access credential data, and a location reference.

13. The system of claim 8 wherein the transaction module comprises a validation module configured to:
(a) validate allocation units through one or more of the following validation criteria:
(i) verifying that total allocated time does not exceed a logical maximum for the time period,
(ii) verifying geospatial feasibility between consecutive interaction locations using a distance-over-time criterion, and
(iii) confirming that each interaction location is an authorized location; and
(b) identify allocation units that fail validation and record validation results in an audit trail.

14. The system of claim 13 wherein the validation module assigns a confidence score to the allocated record based on application of the validation criteria.

15. The system of claim 13 wherein the audit trail associates the tax calculation with the allocated record and its associated data.

16. A database of allocated payments attributable to a plurality of individuals accessing a computing resource platform comprising:
a plurality of allocated records, wherein each allocated record is associated to a user or device and comprises:
one or more transactional base units comprising at least one of the following transaction data type categories: (a) personal identification data, (b) digital access data, (c) facility access credential data, and location data associated with one of the transaction data type categories;
a location assigned to each of the one or more transaction base units based on hierarchical transaction data category analysis;
one or more allocation units based on the number of unique locations identified in the allocated record; and
wherein the database includes a generated output of a dollar amount payable per individual or device per location or computing resource platform.

17. The database of claim 16, wherein the database may be a suitable storage location, such as a data lake, a data warehouse, or a data lake house.

18. The database of claim 16, wherein the hierarchical transaction data category analysis is based on the following hierarchy:
(1) if the transactional base unit includes facility access credential data, using the facility access credential data to identify the location of the individual accessing the CRP;
(2) if the transactional base unit lacks facility access credential data, then using digital access data to identify a location of the individual accessing the CRP; and
(3) if the transactional base unit lacks facility access credential data and digital access data, then using identification data where the identification includes an assigned location for the individual or the device.
